(19) United States
(12) Patent Application Publication
(10) Pub. No.: US 2025/0382162 A1
(43) Pub. Date: Dec. 18, 2025

(54) Variable Counterbalance for a Primary Controlled Drive in a Lifting Apparatus

(71) Applicant: Robert Bosch GmbH, Stuttgart (DE)

(72) Inventors: Jim E. Diehl, Lehighton, PA (US); Jon Frey, Macungie, PA (US)

(21) Appl. No.: 18/744,165

(22) Filed: Jun. 14, 2024

(51) Int. Cl. B66C 23/80

(52) U.S. Cl. CPC B66C 23/80

(57) ABSTRACT

An elongated boom of a heavy-lift machine is pivotably mounted at a pivot mount with the load carried by the free end of the boom, pivoted by a primary actuator connected to a drive end of the boom. A counterbalance component is engaged to the boom to counterbalance the weight-generated torque of the boom. The counterbalance component includes a hydraulic actuator with the piston connected to the boom and a liquid-filled cylinder connected to a gas-filled accumulator in a hydraulic circuit. The gas pressure in the accumulator is adjustable by the fluid provided to the hydraulic actuator. The piston of the counterbalance component applies a counterbalance force to the boom as a function of the pressure of the gas compressed in the accumulator

### BACKGROUND

The present disclosure relates to machines and apparatus for lifting heavy objects, such as robots and cranes. Many lifting machines include a cantilevered boom with the load to be lifted engaged at the free end of the boom. The boom is then rotated about a horizontal axis to raise and lower the free end of the boom, and thus raise and lower the heavy load. Because the machinery is acting against gravity, it is often desirable to use a counterbalance to minimize the required input power to rotate the boom and raise and lower the load.

An exemplary lifting machine shown in FIGS. 1-2 includes a cantilevered boom 10 with a weight W supported at the free end 11 of the boom. The boom is pivotably supported at a relatively fixed pivot mount 12, although it is understood that the pivot mount can be movable with the lifting machine, such as in a mobile crane or robot. The boom extends beyond the pivot mount 12 for connection to the drive end 15 of a primary actuator 14. The boom thus includes a portion having a length L1 between the free end 11 and the pivot mount 12, and a second portion having a length L2 from the pivot mount 12 to the drive end 15 of the actuator. It can be appreciated that as gravity acts on the weight W, a moment or torque T is generated at the pivot mount 12 having a value that is the x-component of the weight vector W times the length L1. This torque generates a force F at the drive end 15 of the primary actuator that must be resisted by the actuator as the actuator is used to raise or lower the boom 10. The significant difference between the moment arm of the weight W and the moment arm to the drive end 15 of the primary actuator causes the force F to be a significant multiple of the weight W, exceeding the ratio of the length L1 and the length L3 from the pivot mount to the drive end.

It can be appreciated that force F resulting from this weight-generated torque assists the primary actuator in lowering the boom. However, this force must be resisted by the primary actuator 14 when the boom is held at a particular orientation. More significantly, this force F opposes the primary actuator in raising the boom. The primary actuator must be capable of generating much more power than is needed to simply lift the weight W, with the power requirement increased by the force F.

Consequently, lifting machines, particularly heavy-lifting machines, include a counterbalance to oppose the torque T generated by the weight W at the free end of the cantilevered boom 10. Rather than having the primary actuator 14 absorb the torque T generated by the cantilevered weight, the lifting machine includes a counterbalance component 16 that opposes the weight-generated moment, with the goal of reducing the torque T at the pivot mount 12 to essentially zero. In certain lifting machines, a hydraulic shock absorber is provided as the counterbalance component 16. The hydraulic shock absorber includes a piston 17 slidably disposed within an oil-filled cylinder 18. The piston 17 is connected to the boom 10 at a location between the free end 11 and the pivot mount 12. The weight-generated moment generates a force C that is absorbed by the shock absorber 16 as the piston 17 moves through the fluid within the cylinder 18.

In the orientation shown in FIG. 1, the angle of the weight W relative to the boom 10 is Θ1, so the x-component of the weight vector Wx that generates the torque T is given by the equation Wx=W sinΘ1. The torque T is given by the equation Wx*L1, or L1*W*sinΘ1. The force Cx needed to counterbalance this torque is Wx*L1/L3, there L3 is the distance of the shock absorber 17 connection to the boom 10 to the pivot mount 12. The force Cx is the x-component of the vector force C that must be resisted by the shock absorber—i.e., Cx=C*sinΘ2. The force C due to the weight-generated torque T that must be counterbalanced by the shock absorber to counterbalance is therefore

$$C = W * \frac{L 1}{L 3} * \frac{sin Θ 1}{sin Θ 3} . \qquad ( Equation 1 )$$

The counterbalance force C is thus a function of the lengths L1, L3 and the angles Θ1, Θ2.

When the boom is lowered, as shown in FIG. 2, the angles Θ1 and Θ2 change and the torque-generating weight component Wx increases. Ultimately, the force C′ that must be counterbalanced by the shock absorber increases, primarily because the angle Θ1′ of the weight relative to the boom 10 increases. It should also be appreciated that the shock absorber is resisting the pivoting of the boom 10 due to a desired activation of the primary actuator 14, especially as the boom moves lower.

For any lifting device, the weight of the load that is being moved will necessarily vary from one application to another—even within a single job operation. The weight being lifted at one moment in the job might be 500 lbs, and then at a later moment in the job the weight might be 1000 lbs. The shock absorber must necessarily be adapted to handle the largest possible load for the job, which makes the shock absorber less effective for the smaller weight loads that would be lifted for the majority of any particular job. There is a need for a counterbalance system that can handle a wide range of load weights and that can adjust for any position or movement of the boom 10. Moreover, there is a need for a counterbalance system that actively keeps the extra load on the primary actuator 14 as low as possible, regardless of the orientation or angular attitude of the boom of the lifting device.

### SUMMARY

A heavy-lift machine comprises an elongated boom pivotably mounted at a pivot mount in which the free end of the boom is configured to carry a load to be raised and lowered by the boom. The boom has a first length from the free end to the pivot mount, and a second length from the pivot mount to an opposite drive end of the boom. A primary actuator is connected to the drive end of the boom and is operable to move the drive end to pivot the boom about the pivot mount. The heavy-lift machine further includes a counterbalance component including a hydraulic actuator having a piston slidably disposed within a liquid-filled cylinder. The piston is connected to the boom at a position between the free end and the pivot mount. The counterbalance component further includes a hydraulic circuit connected to the cylinder by an input line. The hydraulic circuit includes an accumulator interposed in the input line, the accumulator including a gas-filled chamber in which the gas in the chamber is pressurized by liquid, such as hydraulic oil, within the input line and the liquid-filled cylinder of the hydraulic actuator. The piston of the counterbalance component applies a counterbalance force to the boom as a function of the pressure of the gas in the accumulator.

The heavy-lift machine further includes a controller that is configured to monitor a power output by the primary actuator during an operation cycle moving the load. The controller adjusts the gas pressure in the accumulator, to thereby adjust the counterbalance force provided by the counterbalance component, to optimize the measured power output for moving the particular load. The optimized accumulator gas pressure for optimized power to move a particular known load can be stored for several known loads. The heavy-lift machine can then be initially configured according to the stored gas pressure prior to commencement of an operation cycle with a known load.

### DESCRIPTION OF THE DRAWINGS

FIG. 1 is a schematic representation of a prior art lifting machine in a first orientation.

FIG. 2 is a schematic representation of a prior art lifting machine shown in FIG. 1, with the machine in a second orientation.

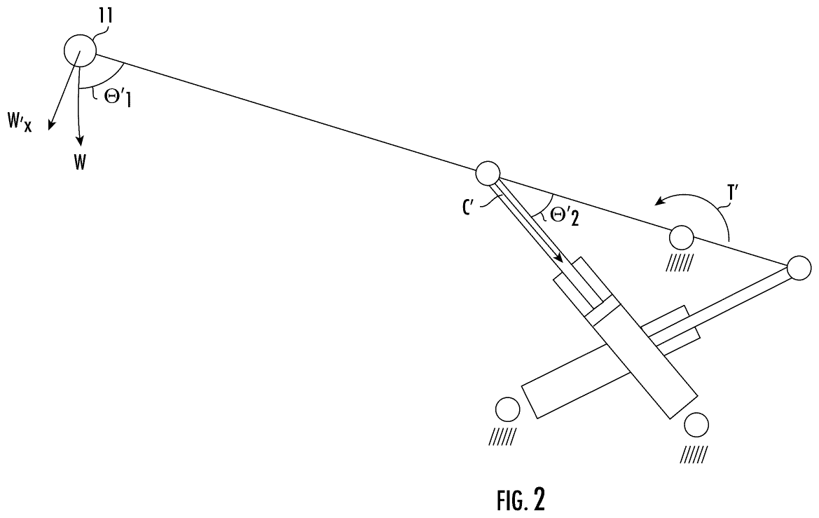

FIG. 3 is a hydraulic diagram of the hydraulic controls for the primary actuator and counterbalance component of a lifting mechanism according to the present disclosure.

FIG. 4 is a flowchart of a method for adjusting the counterbalance force applied by the counterbalance component of the lifting mechanism according to the present disclosure.

FIG. 5 is a flowchart of another method for adjusting the counterbalance force applied by the counterbalance component of the lifting mechanism according to the present disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

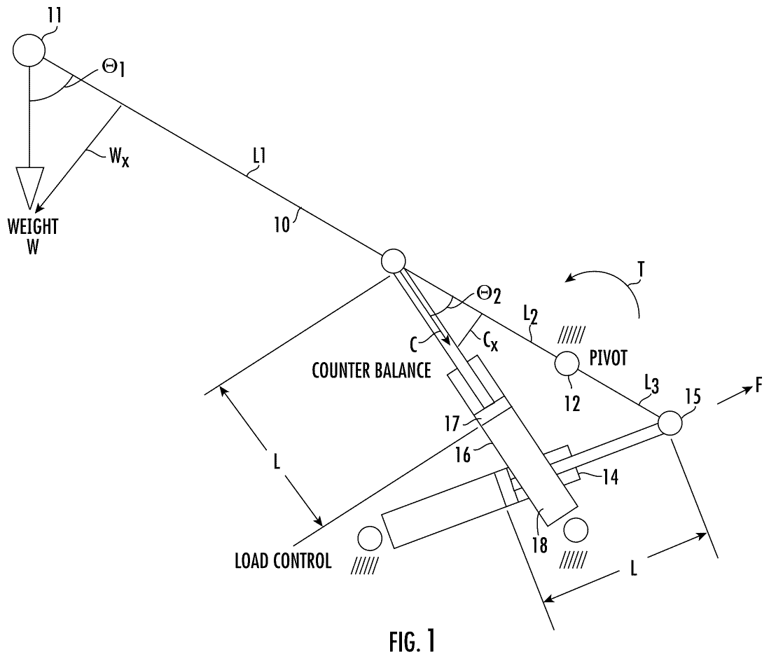

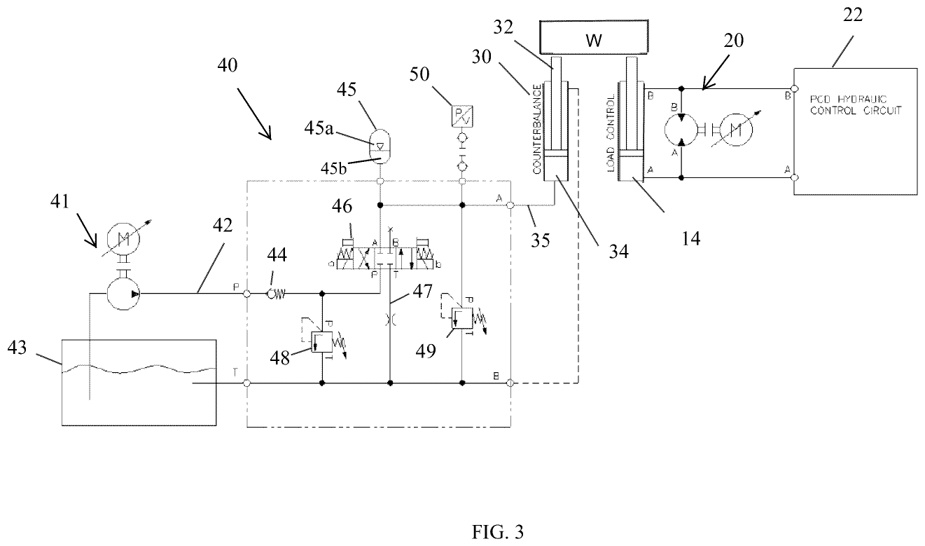

In accordance with the present disclosure, the heavy lifting machine shown in FIG. 1 is modified to replace the shock absorber with a hydraulic actuator. As shown in the hydraulic schematic of FIG. 3, the primary actuator 14 shares the load of the weight W with a hydraulic actuator 30. The actuator 30 includes a piston 32 that is connected to the boom 10 at a position between the free end 11 and the pivot mount 12, like the piston 17 shown in FIG. 1. The piston travels within a fluid-filled cylinder chamber 34 that is supplied by the hydraulics shown in FIG. 3. The primary actuator 14 can be the same as the actuator in FIG. 1, engaging the boom 10 on the opposite side of the pivot mount 12. The primary actuator is driven by a first hydraulic drive 20, that can include an electric motor and hydraulic pump, under control of a primary controlled drive (PCD) controller 22. In one embodiment of the present disclosure, the controller 22 includes a computer processor configured to execute software for controlling the operation of the motor and pump of the first hydraulic drive. It is understood that other primary actuators are contemplated that are capable of applying a force to pivot the boom 10 as described above. For instance, the hydraulic actuator piston and cylinder and first hydraulic drive can be replaced with a linear electric drive in which the motor drives a control rod or similar component connected to the boom or a rotary drive connected directly to the drive end of the boom at the pivot mount 12. The motor of the electric drive can be monitored and controlled by the PCD controller 22 in the same manner as the first hydraulic drive.

The counterbalance actuator 30 is pressurized by a second hydraulic drive 41, which includes an electric motor and hydraulic pump, that draws fluid from a sump 43 and supply flow through a feed line 42. In the present embodiment, the fluid is a generally non-compressible oil, such as a silicone oil. The feed line 42 from the pump is fed through a one-way valve 44 and a controllable 3-way valve 46 to the input line 35 of the actuator 30. The 3-way valve 46 is operable in a first position to connect the actuator input line 35 to the pump feed line 42 and operable in a second position to connect the input line 35 to a fluid return line 47 that is connected to the sump 43. The valve 46 also includes an intermediate neutral position in which the inlet line 35 is closed to hold the pressurized fluid in the actuator cylinder. An adjustable pressure relief valve 48 is connected between the sump 43 and the feed line 42, prior to the 3-way valve 46. Another adjustable pressure relief valve 49 is connected between the sump 43 and the input line 35, prior to the actuator.

In one feature of the present disclosure, an accumulator 45 is interposed in the input line 35 between the 3-way valve 46 and the actuator 30. In one embodiment, the accumulator 45 includes a gas-filled chamber 45a that is pressurized by fluid in the fluid chamber 45b from the actuator 30 and the second hydraulic drive 41. In one embodiment, the gas is nitrogen. The pressure of the gas in chamber 45a is controlled by the amount of fluid introduced into the input line 35 and cylinder chamber 34 of the actuator 30. The initial compression of the gas in chamber 45a controls the counterbalance force over the stroke of the piston 32 of the actuator 30. As the piston retracts due to the weight W, and when the 3-way valve 46 is in its neutral position, the fluid from the actuator 30 further compresses the gas in chamber 45a from the initial compression. This further compression provides additional force as the hydraulic actuator retracts, thereby increasing the counterbalance load resistance in proportion to the increase in weight-generated torque. A pressure transducer 50 in the input line 35 measures the pressure in the line, which is a measure of the counterbalance load resistance.

Thus, unlike the passive shock absorber of the prior art, the heavy-lift machine of the present disclosure uses an active hydraulic actuator. The actuator 30 is driven by the hydraulic circuit shown in FIG. 3 in a manner that enables adjustment of the counterbalance opposing force for different loads/weights and loading conditions. In particular, additional fluid pumped into the chamber 45b of the accumulator 45 increases the initial compression of the gas in the chamber 45a, whereas removing fluid from the accumulator chamber 45b reduces the initial compression of the gas. When the 3-way valve 46 is in its neutral position (i.e., when the feed line 42a and return line 47 are closed), this initial compression of the gas in the accumulator 45 provides an additional, and adjustable, force as the piston 32 of the actuator 30 is retracted by the force C generated by the cantilevered weight W. The initial compression in the accumulator 45 can be adjusted according to the weight W being moved by the boom 10. It is contemplated that this weight-based adjustment can occur prior to moving the weight, between movement cycles as well as during a movement cycle of raising and lowering the weight.

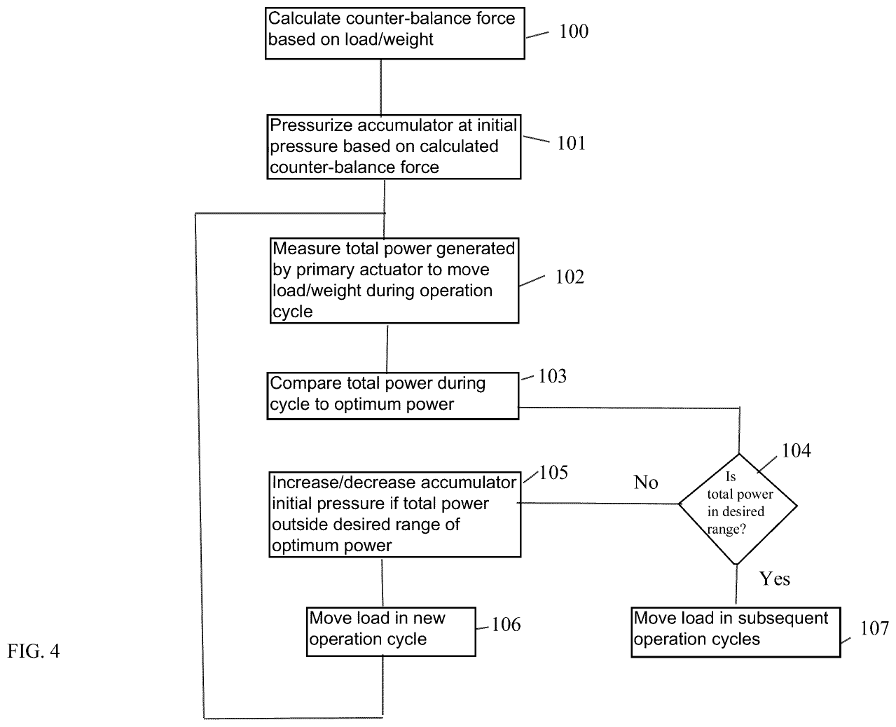

The processor of the PCD controller 22 is further configured to monitor the total power generated by the primary actuator 14 during the course of moving the load W according to the particular job. In one embodiment, the PCD controller is configured to monitor the power output of the motor of the first hydraulic drive 20 used to drive the primary actuator 14 during an operation cycle, such as by measuring the motor voltage and current. (It is contemplated that in some embodiments, the first hydraulic drive 20 can also reclaim energy as the load is lowered.) In embodiments in which the primary controller is an electric drive, the PCD controller can similarly monitor the power of the motor. A complete operation cycle includes lifting and lowering the load/weight W according to the particular job. Before the first operation cycle, the initial compression of the gas in the accumulator 45 is determined as a function of the weight being lifted using Equation 1 above in Step 100 of the flowchart in FIG. 4. The counterbalance force C at the initial position of the heavy lifting machine can be used to calculate the cylinder pressure by dividing the force C by the area of the piston 32. This calculation can occur separate from the PCD controller or can be performed by the processor based on input data concerning the geometry of the heavy-lift machine and the load W being lifted found in Equation 1. The processor of the controller 22 is configured to receive data from the pressure transducer 50 and to determine the gas pressure in the accumulator 45. In Step 101, the controller directs the valve 46 to be opened and the second hydraulic drive 41 to be activated to pressurize the accumulator 45 until the desired gas pressure is reached, as measured by the pressure transducer 50. The controller then directs the valve 46 to be moved to the intermediate position in which the valve is closed to hold the accumulator at the initial gas compression during the operation cycle. It can be appreciated that the 3-way valve 46 can be operated by a solenoid receiving control signals from the processor in controller 22. Likewise, the hydraulic drive 41 can be actuated by signals from the controller to the motor of the drive 41.

The total power needed to lift and lower the load is measured during a complete operation cycle in Step 102 and compared in Steps 103-104 to a desired power range. In one embodiment, the desired power range can be set around a nominal total power to move the weight during the complete operation cycle for a particular job under ideal conditions-i.e., with the load perfectly counterbalanced throughout the operation cycle. Again, power measurement and comparison can be implemented according to software commands executed by the controller 22. The controller can store power range information for pre-determined operation cycles moving known loads, with the desired power range selected for the comparison steps 103-104. Based on the comparison in step 104, the processor of the controller determines how the counterbalance force needs to be adjusted. The counterbalance force C can be adjusted up or down by increasing or decreasing, respectively, the gas pressure in the accumulator 45 in Step 105. As described above, the pressure in the chamber 45a can be increased by moving the 3-way valve 46 to the first position and activating the second hydraulic drive 41 until the desired pressure is read by the transducer 50 and acknowledged by the controller 22. Alternatively, if the gas pressure in the accumulator chamber 45a is to be reduced, the valve can be moved to its second position in which the inlet line 35 is open to the return line 47 so that the hydraulic pressure bleeds off until the desired pressure is read by the transducer and conveyed to the controller 22.

Returning to FIG. 4, after the accumulator pressure has been adjusted, the next operation cycle is commenced in Step 106. The total power determination is made with the next and successive operation cycles to iterate to an optimum counterbalance force C and accumulator pressure by repeating Steps 102-106. Once the total power measured during an operation cycle falls within the desired range, as determined in Step 104, the updated accumulator pressure is maintained throughout all subsequent operation cycles in Step 107. At this point, the counterbalance applied by the actuator 30 has been calibrated for the particular load/weight W and operation cycle so that the total power required to move the weight in successive operation cycles is optimized. When a new and different weight W is to be moved, the iterative process can be applied to identify the optimum gas pressure in the accumulator 45 for that new weight.

Once an optimum gas pressure for the accumulator 45 has been determined for a particular load/weight W, that pressure can be stored in a memory associated with the controller 22 and accessed whenever the particular load is to be moved. Thus, the iterative process outlined above is no longer needed for a known load. A database of optimum initial accumulator pressures can be established for several different known loads/weights. The controller 22 can be configured to permit selection of a particular weight in the data base and to bypass the iterative process in Steps 102-106. The pressure can still be monitored by the transducer 50 and the total energy for each load cycle can still be measured by the PCD controller 22 to ensure that the accumulator pressure is still optimum for the particular load.

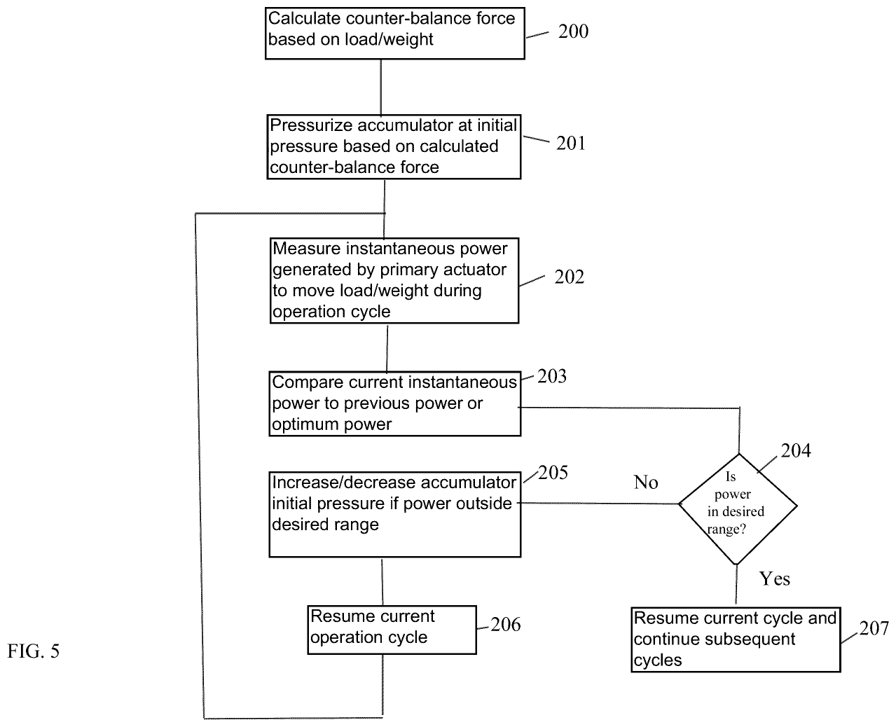

In another embodiment, it is contemplated that the pressure of the gas in chamber 45a of the accumulator 45 can be interactively adjusted during an operation cycle of the heavy lift machine. In this embodiment, the power applied by the primary actuator 14 is continuously monitored during the operation cycle. An increase in the power outside a predetermined range is indicative of an unbalance of the shared load/weight W so that the first hydraulic drive 20 must increase the power to account for the weight-generated torque T. In this instance, the operation cycle can be temporarily halted, the controller can issue instructions to activate the second hydraulic drive 41 and move the 3-way valve 46 to its first position to introduce more fluid into the input line 35 to increase the gas pressure in the chamber 45a of the accumulator 45. The 3-way valve is then closed and the operation cycle continued for a new measurement of the power applied by the primary actuator 14. In this embodiment, initial accumulator pressure is determined in Steps 200-201 in the flowchart of FIG. 5 in the manner previously described. In Step 202 the instantaneous power applied by the primary actuator is measured. The comparison in Steps 203-204 can be between the current instantaneous power and an instantaneous power at an earlier time in the operation cycle, or between the current instantaneous power and an optimum power value. If the current power is outside the desired range, the accumulator pressure can be increased or decreased as needed in Step 205, preferably with the operation cycle halted as the second hydraulic drive and 3-way valve are actuated to change the gas pressure in the accumulator. Once the new accumulator pressure is established, the operation cycle is resumed in Step 206. If the instantaneous power measured in Step 202 is within the desired range, as determined in Step 204, the current cycle is resumed and the updated accumulator pressure is maintained when the current cycle is resumed and in all subsequent operation cycles in Step 207.

The heavy-lift machine of the present disclosure incorporates an active hydraulic actuator and an associated gas-filled accumulator to counterbalance the shared load W with the primary actuator. The controller 22 and hydraulic circuit 40 allows adjustment of the counterbalance force applied by the counterbalance component 30 when a new load W is being moved, until an optimum counterbalance force is achieved. Optimizing the counterbalance force reduces the power requirement for the primary actuator, which allows the use of a smaller primary load control than with prior machines, and which improves overall energy efficiency of the heavy-lift machine. Moreover, the controller and hydraulic circuit allow adjustment of the counterbalance for multiple loads and operation cycles. The accumulator gas pressure requirements for optimum counterbalance of known loads can be stored in memory and called up with each new job involving the known load.

The present disclosure should be considered as illustrative and not restrictive in character. It is understood that only certain embodiments have been presented and that all changes, modifications and further applications that come within the spirit of the disclosure are desired to be protected.

What is claimed is:

1. A heavy-lift machine comprising:
an elongated boom pivotably mounted at a pivot mount in which the free end of the boom is configured to carry a load to be raised and lowered by said boom, said boom having a first length from said free end to said pivot mount, and a second length from said pivot mount to an opposite drive end of said boom;
a primary actuator connected to said drive end of said boom and operable to move said drive end to pivot said boom about said pivot mount;
a counterbalance component including a hydraulic actuator having a piston slidably disposed within a fluid-filled cylinder, said piston connected to said boom at a position between said free end and said pivot mount; and
a hydraulic circuit connected to said cylinder of said counterbalance component by an input line, said hydraulic circuit including;
an accumulator interposed in said input line, said accumulator including a fluid chamber fluidly connected to said input line and a gas-filled chamber, in which the gas in said chamber is compressed by fluid within said fluid chamber, said input line and said fluid-filled cylinder of the hydraulic actuator;
a pressure transducer interposed in said input line between said accumulator and said cylinder of said hydraulic actuator, said transducer configured to determine the pressure of the gas in said accumulator; and
a hydraulic drive fluidly connected to said input line to pump hydraulic fluid into said input line, said cylinder of the hydraulic actuator and said accumulator; and
a controller configured to control said hydraulic circuit to pump hydraulic fluid into or release hydraulic fluid from said input line to adjust the pressure of the gas in said accumulator,
wherein the piston of the counterbalance component applies a counterbalance force to said boom as a function of the pressure of the gas compressed in said accumulator.

2. The heavy-lift machine of claim 1, wherein said hydraulic circuit includes a 3-way valve between said hydraulic drive and said input line, said 3-way valve moveable to a first position in which said input line is fluidly connected to said hydraulic drive, a second position in which said input line is fluidly connected to a sump and an intermediate position in which said input line is closed.

3. The heavy-lift machine of claim 1, wherein said controller includes a computer processor operable to determine that a pressure value obtained from said pressure transducer is outside a desired pressure range and, in response, to actuate said hydraulic circuit to pump hydraulic fluid into or release hydraulic fluid from said input line to adjust the pressure of the gas in said accumulator.

4. The heavy-lift machine of claim 3, wherein:
said hydraulic circuit includes a 3-way valve between said hydraulic drive and said input line, said 3-way valve moveable to a first position in which said input line is fluidly connected to said hydraulic drive, a second position in which said input line is fluidly connected to a sump and an intermediate position in which said input line is closed; and
said computer processor of said controller is operable to move said 3-way valve to said first position to pump hydraulic fluid into said input line to thereby increase the pressure of the gas in the accumulator, and to move said 3-way valve to said second position to connect said input line to said sump to remove hydraulic fluid from said input line to thereby decrease the pressure of the gas in the accumulator.

5. The heavy-lift machine of claim 1, wherein said controller is configured to:
measure power output of said primary actuator during movement of said drive end to pivot said boom;
compare the measured power output to a predetermined power range; and
control said hydraulic circuit to adjust the pressure of the gas in said accumulator if the measured power is outside the predetermined power range.

6. The heavy-lift machine of claim 5, wherein said controller is configured to:
measure said power output during a complete operation cycle of movement of the load;
control said hydraulic circuit to adjust the pressure of the gas in said accumulator upon completion of the complete operation cycle; and
maintain the adjusted gas pressure during a subsequent operation cycle.

7. A method for optimizing the counterbalance for a heavy-lift machine having an elongated boom pivotably mounted at a pivot mount in which the free end of the boom is configured to carry a load to be raised and lowered by said boom, a primary actuator connected to a drive end of said boom and operable to move said drive end to pivot said boom about said pivot mount, and a counterbalance component including a hydraulic actuator having a piston slidably disposed within a fluid-filled cylinder, said piston connected to said boom at a position between said free end and said pivot mount, and said fluid-filled cylinder connected to a gas-filled accumulator in which the pressure of the gas in the accumulator is adjustable by adjusting the fluid provided to the fluid-filled cylinder, the method including the steps of:
setting an initial gas pressure in said accumulator;
moving said load through an operation cycle and measuring the power output of said primary actuator during said operation cycle;
comparing the measured power output to a desired power range; and
adjusting the gas pressure in the accumulator if the measured power output is outside said desired power range.

8. The method of claim 7, wherein:
the step of measuring the power output includes measuring the total power output over the complete operation cycle;
the step of adjusting the gas pressure occurs at the end of the complete operation cycle.

9. The method of claim 8, wherein the method further comprises:
starting a new operation cycle with a similar load with the adjusted gas pressure set as the initial gas pressure in said accumulator; and
iteratively executing the moving, comparing and adjusting steps over successive operation cycles until the measured power output falls within said desired power range.

10. The method of claim 7. wherein:
the step of measuring the power output includes measuring the instantaneous power output during the operation cycle; and
the step of adjusting the gas pressure occurs during the operation cycle.
